(19) United States
(12) Patent Application Publication
(10) Pub. No.: US 2023/0090122 A1
(43) Pub. Date: Mar. 23, 2023

(54) PHOTOGRAPHING CONTROL DEVICE, SYSTEM, METHOD, AND NON-TRANSITORY COMPUTER-READABLE MEDIUM STORING PROGRAM

(71) Applicant: NEC Corporation, Minato-ku, Tokyo (JP)

(72) Inventors: Yusuke MORI, Tokyo (JP); Takeshi Yamaguchi, Tokyo (JP); Honami Yuki, Tokyo (JP); Shuuji Kikuchi, Tokyo (JP)

(73) Assignee: NEC Corporation, Minato-ku, Tokyo (JP)

(21) Appl. No.: 17/801,103

(22) PCT Filed: Mar. 10, 2020
(86) PCT No.: PCT/JP2020/010338

§ 371 Date: Aug. 19, 2022

(51) Int. Cl. G06V 40/16; G06V 40/20; G06V 10/22; G06V 40/50; G06F 21/32

(52) U.S. Cl. CPC G06V 40/172; G06V 40/168; G06V 40/20; G06V 10/22; G06V 40/50; G06F 21/32

(57) ABSTRACT

A photographing control device includes an acquiring unit that acquires a first photographed image obtained by a first photographing device and capturing multiple persons; an authentication controlling unit that causes an authentication device storing in advance first facial feature information of a first person to perform facial authentication of the first photographed image by use of the first facial feature information; and an identifying unit that identifies a second person making a gesture similar to a gesture of the first person in the first photographed image, if the facial authentication has succeeded.

### TECHNICAL FIELD

The present invention relates to photographing control devices, systems, methods, and non-transitory computer-readable media storing programs and relates, in particular, to a photographing control device, a system, a method, and a non-transitory computer-readable medium storing a program each for registering an image for facial authentication in a group.

### BACKGROUND ART

Patent Literature 1 discloses a technique of estimating a group attribute indicating whether a plurality of persons are acting in a group when the plurality of persons are detected within a photographed image. The system described in Patent Literature 1 can, from accumulated facial images, search for a person acting alone or persons acting together.

Meanwhile, Patent Literatures 2 and 3 disclose a technique of detecting a facial image from a photographed image and adding mosaic to a facial image of a person other than a specific person. Patent Literature 4 discloses a technique of recognizing a gesture of a subject in a photographed image.

### CITATION LIST

### Patent Literature

Patent Literature 1: International Patent Publication No. WO2018/180588

Patent Literature 2: Japanese Unexamined Patent Application Publication No. 2004-062560

Patent Literature 3: Japanese Unexamined Patent Application Publication No. 2011-182028

Patent Literature 4: Japanese Unexamined Patent Application Publication No. 2015-043141

### SUMMARY OF INVENTION

### Technical Problem

According to Patent Literature 1, group members need to be identified in order to estimate a group attribute. However, in order to identify the group members, facial images of all the group members for facial authentication need to be registered in advance, but it is cumbersome to do so.

The present disclosure has been made to solve such a problem and is directed to providing a photographing control device, a system, a method, and a program for readily identifying group members.

### Solution to Problem

A photographing control device according to the present disclosure includes: acquiring means for acquiring a first photographed image obtained by a first photographing device and capturing multiple persons; authentication controlling means for causing an authentication device storing in advance first facial feature information of a first person to perform facial authentication of the first photographed image by use of the first facial feature information; and identifying means for identifying a second person making a gesture similar to a gesture of the first person in the first photographed image, if the facial authentication has succeeded.

A photographing control device according to the present disclosure includes: storing means for storing first facial feature information of a first person; acquiring means for acquiring a first photographed image obtained by a first photographing device and capturing multiple persons; authenticating means for performing facial authentication of the first photographed image by use of the first facial feature information; and identifying means for identifying a second person making a gesture similar to a gesture of the first person in the first photographed image, if the facial authentication has succeeded.

A photographing control system according to the present disclosure includes: a photographing control device; an authentication device including storing means configured to store in advance first facial feature information of a first person and authenticating means configured to perform facial authentication by use of the first facial feature information; and a first photographing device, wherein the photographing control device is configured to acquire a first photographed image obtained by the first photographing device and capturing multiple persons, cause the authentication device to perform facial authentication of the first photographed image by use of the first facial feature information, and identify a second person making a gesture similar to a gesture of the first person in the first photographed image, if the facial authentication has succeeded.

A photographing control method according to the present disclosure executed by a computer includes: acquiring a first photographed image obtained by a first photographing device and capturing multiple persons; causing an authentication device storing in advance first facial feature information of a first person to perform facial authentication of the first photographed image by use of the first facial feature information; and identifying a second person making a gesture similar to a gesture of the first person in the first photographed image, if the facial authentication has succeeded.

A photographing control method according to the present disclosure executed by a computer including storing means configured to store first facial feature information of a first person includes: acquiring a first photographed image obtained by a first photographing device and capturing multiple persons; performing facial authentication of the first photographed image by use of the first facial feature information; and identifying a second person making a gesture similar to a gesture of the first person in the first photographed image, if the facial authentication has succeeded.

A non-transitory computer-readable medium according to the present disclosure has a program recorded thereon, the program causing a computer to execute: a process of acquiring a first photographed image obtained by a first photographing device and capturing multiple persons; a process of causing an authentication device storing in advance first facial feature information of a first person to perform facial authentication of the first photographed image by use of the first facial feature information; and a process of identifying a second person making a gesture similar to a gesture of the first person in the first photographed image, if the facial authentication has succeeded.

A non-transitory computer-readable medium according to the present disclosure has a program recorded thereon, the program causing a computer configured to store first facial feature information of a first person to execute: a process of acquiring a first photographed image obtained by a first photographing device and capturing multiple persons; a process of performing facial authentication of the first photographed image by use of the first facial feature information; and a process of identifying a second person making a gesture similar to a gesture of the first person in the first photographed image, if the facial authentication has succeeded.

### Advantageous Effects of Invention

The present disclosure can provide a photographing control device, a system, a method, and a program for readily registering facial images of group members for facial authentication.

### BRIEF DESCRIPTION OF DRAWINGS

FIG. 1 is a block diagram illustrating a configuration of a photographing control device according to a first example embodiment.

FIG. 2 is a flowchart illustrating a flow of a photographing control method according to the first example embodiment.

FIG. 3 is a block diagram illustrating a configuration of a photographing control device according to a second example embodiment.

FIG. 4 is a block diagram illustrating a configuration of a photographing control system according to a third example embodiment.

FIG. 5 is a block diagram illustrating a configuration of an authentication device according to the third example embodiment.

FIG. 6 is a block diagram illustrating a configuration of a facial authentication terminal according to the third example embodiment.

FIG. 7 is a block diagram illustrating a configuration of a user terminal according to the third example embodiment.

FIG. 8 is a flowchart illustrating a flow of a facial information registration process according to the third example embodiment.

FIG. 9 is a flowchart illustrating a flow of a facial authentication process according to the third example embodiment.

FIG. 10 illustrates an example of a photographed image for group registration according to the third example embodiment.

FIG. 11 is a flowchart illustrating a flow of a group registration process according to the third example embodiment.

FIG. 12 is a conceptual diagram illustrating a state held after the group registration process according to the third example embodiment.

FIG. 13 is a block diagram illustrating a configuration of a photographing control system according to a fourth example embodiment.

FIG. 14 is a flowchart illustrating a flow of a group authentication process according to the fourth example embodiment.

FIG. 15 illustrates an example of a photographed image for group authentication according to a fifth example embodiment.

FIG. 16 is a block diagram illustrating a configuration of a photographing control system according to a sixth example embodiment.

FIG. 17 is a flowchart illustrating a flow of a process of generating an edited image according to the sixth example embodiment.

FIG. 18 is a schematic diagram illustrating an example of an edited image according to the sixth example embodiment.

### EXAMPLE EMBODIMENT

Hereinafter, some example embodiments of the present disclosure will be described in detail with reference to the drawings. In the drawings, identical or corresponding elements are given identical reference characters, and duplicate description thereof will be omitted as necessary in order to make the description clearer.

### First Example Embodiment

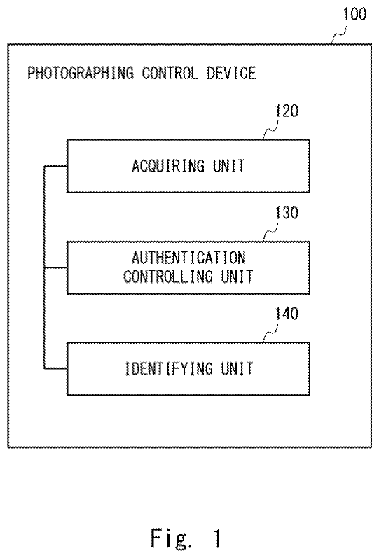

FIG. 1 is a block diagram illustrating a configuration of a photographing control device 100 according to a first example embodiment. The photographing control device 100 includes an acquiring unit 120, an authentication controlling unit 130, and an identifying unit 140. The photographing control device 100 is connected to a network 500 (not illustrated). The network 500 may be a wired network or a wireless network. An authentication device 200 and a first photographing device 700 (neither illustrated) are connected to the network 500.

The acquiring unit 120 acquires a first photographed image obtained by the first photographing device 700 and capturing multiple persons. The first photographing device 700 is, for example, a public camera installed in a public area.

The authentication controlling unit 130 causes the authentication device 200 to perform facial authentication of the first photographed image by use of first facial feature information. The first facial feature information is facial feature information of a first person. In this example, the authentication device 200 stores the first facial feature information of the first person in advance.

The identifying unit 140 identifies a second person making a gesture similar to the gesture of the first person in the first photographed image, if facial authentication has succeeded. A gesture is, for example, showing of a peace sign or posing with a raised hand.

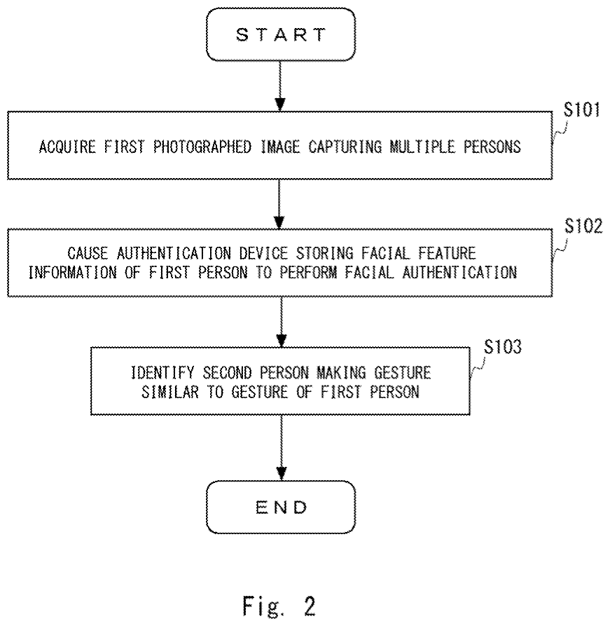

FIG. 2 is a flowchart illustrating a flow of a photographing control method according to the first example embodiment. First, the acquiring unit 120 acquires a first photographed image obtained by the first photographing device and capturing multiple persons (step S101). Next, the authentication controlling unit 130 causes the authentication device 200 to perform facial authentication of the first photographed image by use of the first facial feature information (step S102).

Lastly, if facial authentication has succeeded, the identifying unit 140 identifies a second person making a gesture similar to the gesture of the first person in the first photographed image (step S103).

As described above, it has been difficult, with conventional techniques, to identify group members without having to register images of all the group members for facial authentication. In contrast, the photographing control device according to present example embodiment can identify group members as long as a facial image of one person is registered.

Herein, the photographing control device 100 includes, as its components, a processor, a memory, and a storage device (none illustrated). The storage device stores a computer program that implements the processes of the photographing control method according to the present example embodiment. The processor loads the computer program from the storage device onto the memory and executes the computer program. Thus, the processor implements the functions of the acquiring unit 120, the authentication controlling unit 130, and the identifying unit 140.

Alternatively, the acquiring unit 120, the authentication controlling unit 130, and the identifying unit 140 may each be implemented by a dedicated piece of hardware. A part or the whole of the constituent elements of each device may be implemented by, for example, general-purpose or dedicated circuitry, a processor, or a combination thereof. Such constituent elements may be formed by a single chip or by a plurality of chips connected via a bus. A part or the whole of the constituent elements of each device may be implemented by a combination of the above-described circuitry or the like and a program. For the processor, a central processing unit (CPU), a graphics processing unit (GPU), a field-programmable gate array (FPGA), or the like can be used.

In a case where a part or the whole of the constituent elements of the photographing control device 100 is implemented by a plurality of information processing devices, circuitries, or the like, these information processing devices, circuitries, or the like may be disposed centrally or distributedly. For example, these information processing devices, circuitries, or the like may be implemented in a mode in which they are connected to each other via a communication network, as in, for example, a client server system or a cloud computing system. The function of the photographing control device 100 may be provided in a Software as a Service (SaaS) format.

### Second Example Embodiment

A second example embodiment is a modification example of the first example embodiment described above. The photographing control device 100 according to the first example embodiment performs individual authentication by the external authentication device 200. In contrast, a photographing control device 100 according to the second example embodiment performs individual authentication within the device.

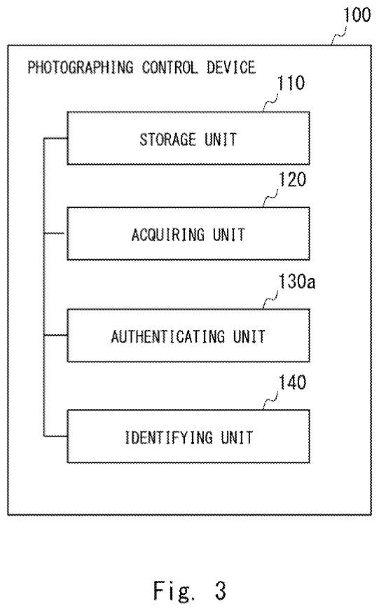

FIG. 3 is a block diagram illustrating a configuration of the photographing control device 100 according to the second example embodiment. The photographing control device 100 includes a storage unit 110, an acquiring unit 120, an authenticating unit 130a, and an identifying unit 140. The functions of the acquiring unit 120 and the identifying unit 140 are similar to those according to the first example embodiment, and thus description thereof will be omitted.

The storage unit 110 according to the second example embodiment stores first facial feature information of a first person. The authenticating unit 130a according to the second example embodiment performs facial authentication of a first photographed image by use of the first facial feature information stored in the storage unit 110.

The flow of a photographing control method according to the second example embodiment is similar to the flow illustrated in FIG. 2. However, at step S103, the authenticating unit 130a performs facial authentication of the first photographed image by use of the first facial feature information stored in the storage unit 110.

In this manner, the second example embodiment too can provide advantageous effects similar to those provided by the first example embodiment described above.

### Third Example Embodiment

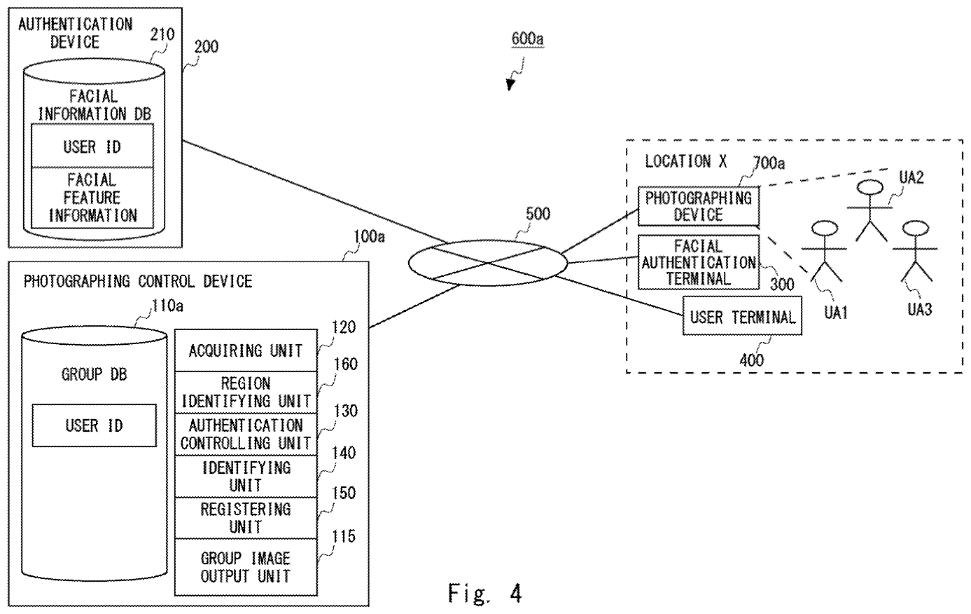

A third example embodiment is a specific example of the first example embodiment described above. FIG. 4 is a block diagram illustrating a configuration of a photographing control system 600a according to the third example embodiment. The photographing control system 600a includes a photographing control device 100a, an authentication device 200, a photographing device 700a, a facial authentication terminal 300, and a user terminal 400. The photographing control device 100a, the authentication device 200, the photographing device 700a, the facial authentication terminal 300, and the user terminal 400 are connected to each other via a network 500.

According to the third example embodiment, a user ID of a first person and facial feature information of this user are registered in advance in a facial feature DB 210 of the authentication device 200. The facial feature DB 210 is also referred to as a storage unit. In this example, the first person is a part of members acting in a group. The first person may be a single person or may include multiple persons. In a group registration process described later, the user IDs of the other members and facial feature information of these users become registered in the authentication device 200. Of the members acting in a group, the persons other than the first person are referred to as a second person.

For example, users UA1, UA2, and UA3 act in a group. First, the user ID and facial feature information of the user UA1 are registered in the authentication device 200. The user UA1 is the first person described above. In the group registration process described later, the user ID and facial feature information of the user UA2 and the user ID and facial feature information of the user UA3 are further registered into a group DB 110a. The users UA2 and UA3 are the second person described above.

According to the present example embodiment, the user ID of the first person is registered in the group DB 110a of the photographing control device 100a. The photographing control device 100a may register the user ID of the first person by acquiring the user ID of the person registered in the facial feature DB 210 and registering the acquired user ID into the group DB 110a. In the group registration process described later, the user IDs of the other members are registered into the group DB 110a. Each function of the photographing control device 100a will be described later.

The authentication device 200 includes the facial feature DB 210 described above. The facial feature DB 210 stores an association between the user ID and facial feature information of a user. The authentication device 200, in response to receiving a facial authentication request from the outside, compares a facial image or facial feature information included in the received request against the facial feature information of the user and returns the result of the comparison to the requestor. According to the third example embodiment, the authentication device 200 performs a comparison regarding the facial feature information of the first person, in response to a facial authentication request.

The photographing device 700a obtains a photographed image for group registration and transmits the photographed image to the photographing control device 100a via the network 500. A location X where the photographing device 700a is installed is, for example, a scramble intersection. The photographing control system 600a can use, as a first photographing device that obtains a photographed image for group registration, any one of the photographing device 700a, the facial authentication terminal 300, or the user terminal 400.

The facial authentication terminal 300 obtains a registration image to be used for facial authentication of the first person. The facial authentication terminal 300 transmits the registration image to the authentication device 200 and makes a facial information registration request. Herein, the facial authentication terminal 300 may transmit facial feature information extracted from the registration image to the authentication device 200 and make a facial information registration request. The facial authentication terminal 300 may be installed at the location X or a location different from the location X. The facial authentication terminal 300 may be digital signage.

The user terminal 400 is a terminal owned by, for example, the first person. The user terminal 400 is, for example but not limited to, a mobile phone terminal, a smartphone, a tablet terminal, or a personal computer (PC) equipped with or connected to a camera. The user terminal 400 transmits, to the authentication device 200, a registration image to be used for facial authentication of the first person and makes a facial information registration request. In this example, the user terminal 400 may transmit facial feature information extracted from the registration image to the authentication device 200 and make a facial information registration request. Herein, the photographing device 700a may transmit a registration image of the first person to the authentication device 200 and make a facial information registration request. In this example, the photographing device 700a may transmit facial feature information extracted from the registration image to the authentication device 200 and make a facial information registration request.

In other words, the facial authentication terminal 300 and the user terminal 400 are each a device that registers facial feature information extracted from a facial image of a first person into the facial information DB 210 prior to group registration, which will be described later.

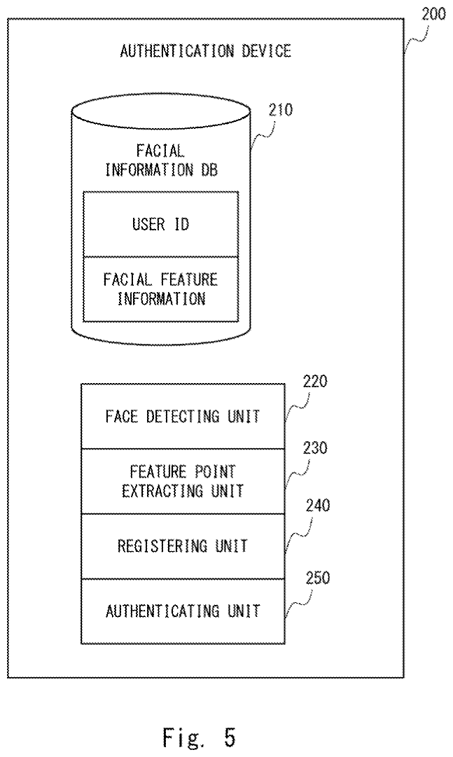

Next, some functions of the authentication device 200 will be described in detail. FIG. 5 is a block diagram illustrating a configuration of the authentication device 200. The authentication device 200 includes the facial information DB 210 described earlier, a face detecting unit 220, a feature point extracting unit 230, a registering unit 240, and an authenticating unit 250.

The face detecting unit 220 detects a facial region included in a registration image for registering facial information and outputs the detected facial region to the feature point extracting unit 230. The feature point extracting unit 230 extracts feature points from each facial region detected by the face detecting unit 220 and outputs facial feature information to the registering unit 240. In this example, the facial feature information is a set of extracted feature points. The feature point extracting unit 230 may also extract feature points included in a facial image received from the photographing control device 100a and output facial feature information to the authenticating unit 250.

The registering unit 240 issues a new user ID when registering facial feature information. The registering unit 240 registers an association between the issued user ID and the facial feature information extracted from the registration image into the facial information DB 210. The authenticating unit 250 compares the facial feature information extracted from the facial image against the facial feature information in the facial information DB 210. According to the third example embodiment, the authenticating unit 250 performs a comparison against the facial feature information of the first person. The authenticating unit 250 returns, to the photographing control device 100a, the presence or absence of a match between the two pieces of facial feature information. The presence or absence of a match between the two pieces of facial feature information corresponds to the success or failure of authentication.

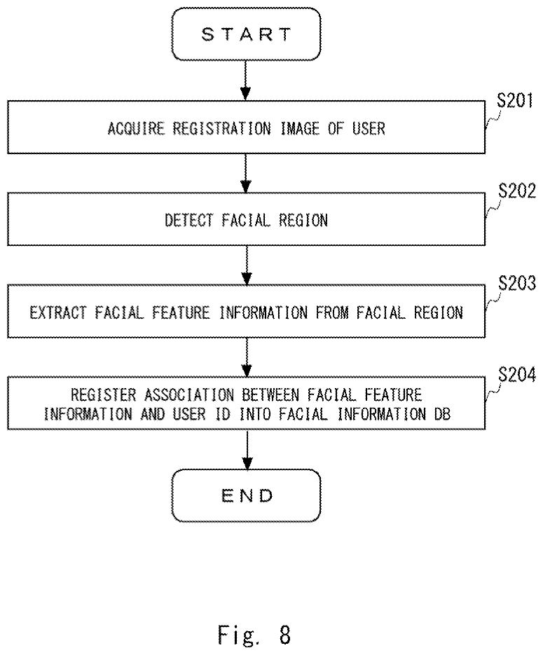

FIG. 8 is a flowchart illustrating a flow of a facial information registration process performed by the authentication device 200. First, the authentication device 200 acquires a registration image included in a facial information registration request (step S201). The authentication device 200 receives the facial information registration request of the first person from, for example, a facial authentication terminal via the network 500. The authentication device 200 receives the facial information registration request of the second person from the photographing control device 100a. The facial information registration request will be described later. Next, the face detecting unit 220 detects a facial region included in the facial image (step S202).

Next, the feature point extracting unit 230 extracts feature points from the facial region detected at step S202 and outputs facial feature information to the registering unit 240 (step S203). Lastly, the registering unit 240 issues a user ID and registers an association between this user ID and the facial feature information into the facial information DB 210 (step S204). Herein, the authentication device 200 may receive facial feature information from a facial authentication terminal or the like and register an association between the facial feature information and the user ID into the facial information DB 210.

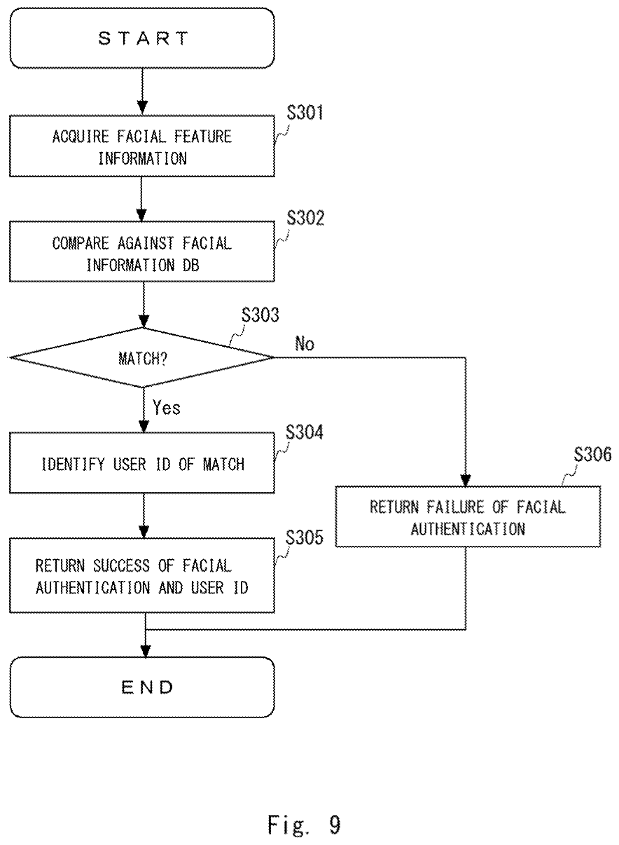

FIG. 9 is a flowchart illustrating a flow of a facial authentication process performed by the authentication device 200. According to the third example embodiment, the authentication device 200 performs facial authentication by use of the facial feature information of the first person. First, the feature point extracting unit 230 acquires facial feature information from a facial image received from the photographing control device 100a (step S301). For example, the authentication device 200 receives the facial image from the photographing control device 100a and extracts the facial feature information as in steps S201 to S203. Alternatively, the authentication device 200 may receive the facial feature information from the photographing control device 100a. Next, the authenticating unit 250 compares the acquired facial feature information against the facial information DB 210 (step S302). If the facial feature information has a match (Yes at step S303), the authenticating unit 250 identifies the user ID of the user that the facial feature information has matched with (step S304) and returns the success of the facial authentication and the identified user ID to the photographing control device 100a (step S305). If the facial feature information has no match (No at step S303), the authenticating unit 250 returns the failure of the facial authentication to the photographing control device 100a (step S306).

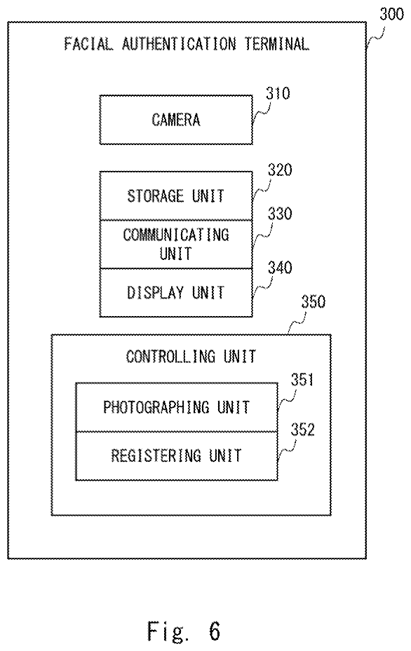

Next, the facial authentication terminal 300 will be described in detail. The facial authentication terminal 300 includes, as its hardware components, a photographing device such as a camera, a display device, and a computer. FIG. 6 is a block diagram illustrating a configuration of the facial authentication terminal 300. The facial authentication terminal 300 includes a camera 310 as mentioned above, a storage unit 320, a communicating unit 330, a display unit 340, and a controlling unit 350. The storage unit 320 is a storage device that stores a program for implementing each function of the facial authentication terminal 300. The communicating unit 330 is a communication interface with the network 500. The display unit 340 is the display device mentioned above. The controlling unit 350 controls hardware components of the facial authentication terminal 300. The controlling unit 350 includes a photographing unit 351 and a registering unit 352.

The photographing unit 351 controls the camera 310 to obtain a registration image of the first person. The registration image is an image that includes at least a facial image of the user. The registering unit 352 transmits a facial information registration request including the registration image to the authentication device 200 via the network 500. The facial authentication terminal 300 may be capable of displaying an output image on a screen of the display unit 340. The photographing unit 351 may control the camera 310 to obtain a photographed image for group registration.

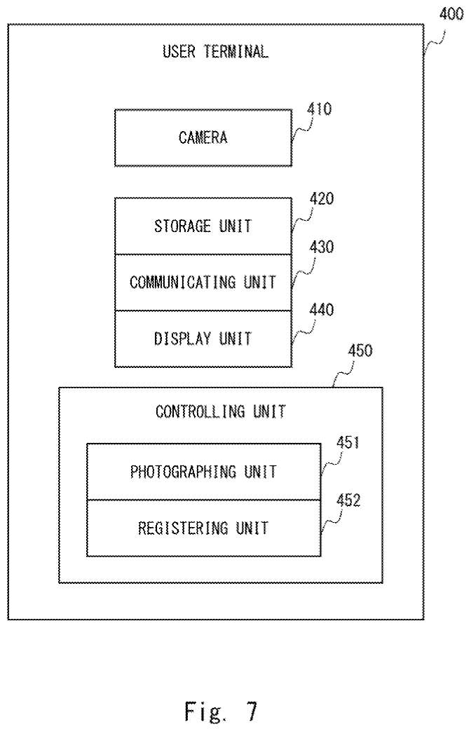

Next, the user terminal 400 will be described. The user terminal 400 is, for example but not limited to, a mobile phone terminal owned by, for example, the first person. FIG. 7 is a block diagram illustrating a configuration of the user terminal 400. Similarly to the facial authentication terminal 300, the user terminal 400 includes a camera 410, a storage unit 420, a communicating unit 430, and a display unit 440. The user terminal 400 further includes a controlling unit 450 that controls the aforementioned hardware components. Similarly to the controlling unit 350 of the facial authentication terminal 300, the controlling unit 450 includes a photographing unit 451 and a registering unit 452. The user terminal 400 may be capable of displaying an output image on a screen of the display unit 440. As with the photographing unit 351 of the facial authentication terminal 300, the photographing unit 451 may control the camera 410 to obtain a photographed image for group registration.

The facial authentication terminal 300 and the user terminal 400 each have a function of making a facial information registration request of the first person. A flow of a facial information registration process will be described below. Although the user terminal 400 is used in the case described below, a similar process may be performed by the facial authentication terminal 300 or the photographing device 700a.

First, the photographing unit 451 controls the camera 410 to obtain a registration image of the first person. Next, the registering unit 452 transmits a facial information registration request including the registration image to the authentication device 200 via the network 500. Lastly, the registering unit 452 receives the result of the authentication from the authentication device 200. Herein, the registering unit 452 may transmit, to the authentication device 200, a facial information registration request including facial feature information extracted from the registration image.

Next, referring back to FIG. 4, some functions of the photographing control device 100a will be described. The photographing control device 100a is an information processing device that performs group registration and is, for example, a server device implemented by a computer. The photographing control device 100a includes the group DB 110a, an acquiring unit 120, a region identifying unit 160, an authentication controlling unit 130, an identifying unit 140, a registering unit 150, and a group image output unit 115. The group DB 110a is a database for managing members belonging to a group. Members belonging to a group are also referred to as users.

The acquiring unit 120 acquires a photographed image for group registration from the photographing device 700a. Herein, the photographed image includes facial regions of multiple persons. In this example, the acquiring unit 120 may acquire the photographed image for group registration from the facial authentication terminal 300 or the user terminal 400.

The acquiring unit 120 controls the photographing device 700a or the facial authentication terminal 300 to obtain the photographed image for group registration. In this example, the acquiring unit 120 may notify the user terminal 400 of the first person of the photographing timing. This is to keep a person who has accidentally made the same gesture from being identified as a second person and being registered as a member of the group.

The region identifying unit 160 identifies a plurality of facial regions from the photographed image for group registration. For example, the region identifying unit 160 recognizes the plurality of facial regions by analyzing the photographed image. In response to the plurality of facial regions having been identified, the authentication controlling unit 130 causes the authentication device 200 to perform facial authentication of each of the identified facial regions by use of the first facial feature information of the first person.

If the authentication controlling unit 130 has succeeded in facial authentication of the first person, the identifying unit 140 identifies a second person making a gesture similar to the gesture of the first person in the photographed image for group registration. A gesture is, for example, showing of a peace sign or posing with a raised hand. The identifying unit 140 extracts feature values of postures of a plurality of persons captured in the registration image for group registration. The identifying unit 140 may extract motion feature values of motions of the plurality of persons captured in the photographed image. The identifying unit 140 identifies a person whose extracted feature value is similar to the feature value of the user UA1. The identifying unit 140 may identify the type of the gesture based on a feature of the user UA1 and identify a person making the same gesture.

Herein, the identifying unit 140 may identify, among the persons making a gesture similar to the gesture of the user UA1, only a person whose distance from the user UA1 is no greater than a predetermined value as a second person. This is to keep a person accidentally making the same gesture at a location where the distance from the user UA1 is no less than a predetermined distance from being identified as a group member.

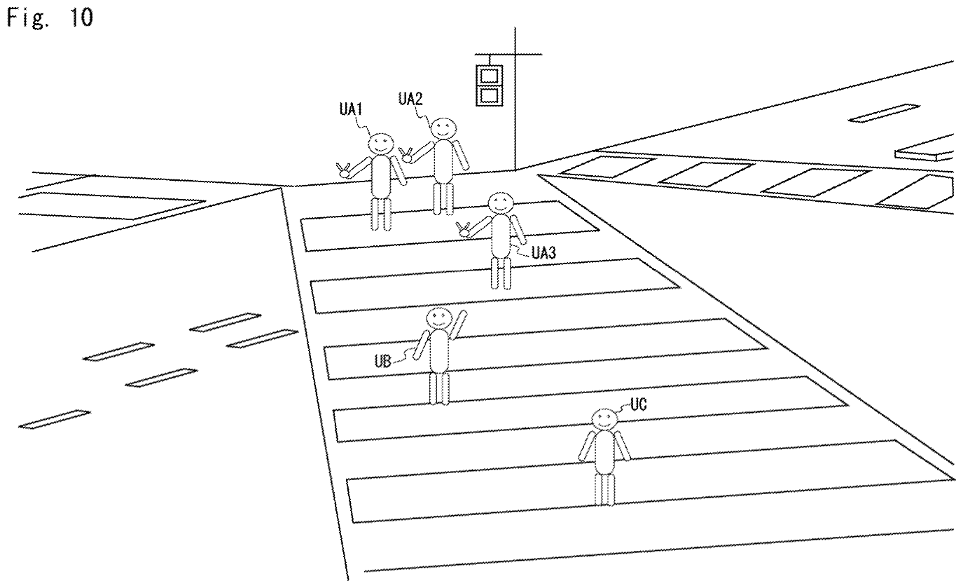

FIG. 10 illustrates an example of a photographed image for group registration obtained by the photographing device 700a or the like according to the third example embodiment. The photographed image includes, as a plurality of persons, users UA1, UA2, UA3, UB, and UC. The user ID of the user UA1 is registered in the group DB 110a. The users UA2 and UA3 are each making the same gesture as the user UA1. The user UB is making a gesture different from the gesture of the user UA1. The user UC is not making any specific gesture. In this case, the identifying unit 140 identifies the users UA2 and UA3.

The registering unit 150 registers, into the authentication device 200, facial feature information of the users UA2 and UA3 identified by the identifying unit 140. In this example, the registering unit 150 transmits a facial information registration request including the registration image of the second person to the authentication device 200 via the network 500. The registration image of the second person is an image of the facial regions of the persons identified by the identifying unit 140.

The registering unit 150 issues a group ID, generates group information associating the issued group ID with each of the user IDs, and registers the generated group information into the group DB 110a. This configuration makes it possible to readily register a registration image for facial authentication of group members.

Herein, the registering unit 150 may register, among the persons making a gesture similar to the gesture of the user UA1, only the person whose distance from the user UA1 is no greater than a predetermined distance into the authentication device 200. This is to keep a person accidentally making the same gesture from being registered as a group member.

The registering unit 150 may transmit, to the user terminal 400, an image for confirmation in which the first person whose facial authentication has succeeded and the second person identified by the identifying unit 140 are highlighted. In this case, the registering unit 150 can perform group registration in accordance with the user's confirmation result.

The registering unit 150 may display a confirmation screen that includes a message prompting for confirmation and the facial images of the first and second persons on the user terminal 400 after the photographing and before the group registration. The message prompting for confirmation is, for example, “OK to register users UA1, UA2, and UA3 as a group?”

The group image output unit 115 outputs an image including the first person and the second person as a group image. In this example, the group image may be a first photographed image or a part of the first photographed image. The group image output unit 115 may output the group image to the facial authentication terminal 300, such as digital signage, or to the user terminal 400 of a user registered as a group. In a case where the group image is output to the user terminal 400, the assumption is that the user is logged in to the terminal with his or her user ID. Herein, the second person has acquired the user ID as a result of the group registration. The group image output unit 115 may output the group image after or before the group registration.

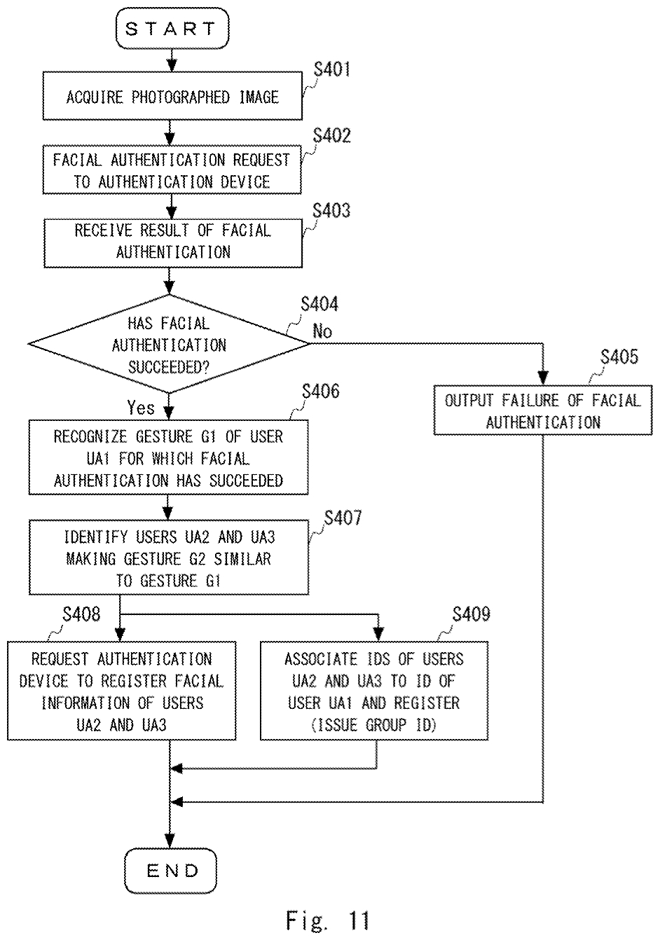

FIG. 11 is a flowchart illustrating an example of a flow of a group registration process according to the present example embodiment. The photographing control device 100a first acquires a photographed image for group registration (step S401). Next, the photographing control device 100a requests the authentication device 200 to perform facial authentication of a facial region identified from the photographed image for group registration (step S402). Next, the photographing control device 100a receives the result of the facial authentication (step S403) and determines whether the facial authentication has succeeded (step S404).

If the facial authentication has failed (No at step S404), the photographing control device 100a outputs the failure of the facial authentication (step S405). If the facial authentication has succeeded (Yes at step S404), the photographing control device 100a identifies a gesture g1 of the user UA1 for which the facial authentication has succeeded (step S406). Next, the photographing control device 100a identifies, from the photographed image, the users UA2 and UA3 each making a gesture g2 similar to the gesture g1 (step S407). Lastly, the photographing control device 100a requests the authentication device 200 to register facial information of the users UA2 and UA3 (step S408). In addition, the photographing control device 100a registers an association between the user ID of the user UA1 and the user IDs of the users UA2 and UA3 (step S409). Herein, the photographing control device 100a may transmit the result of the group registration to the user terminal 400. The result of the group registration may include the user ID of the second person.

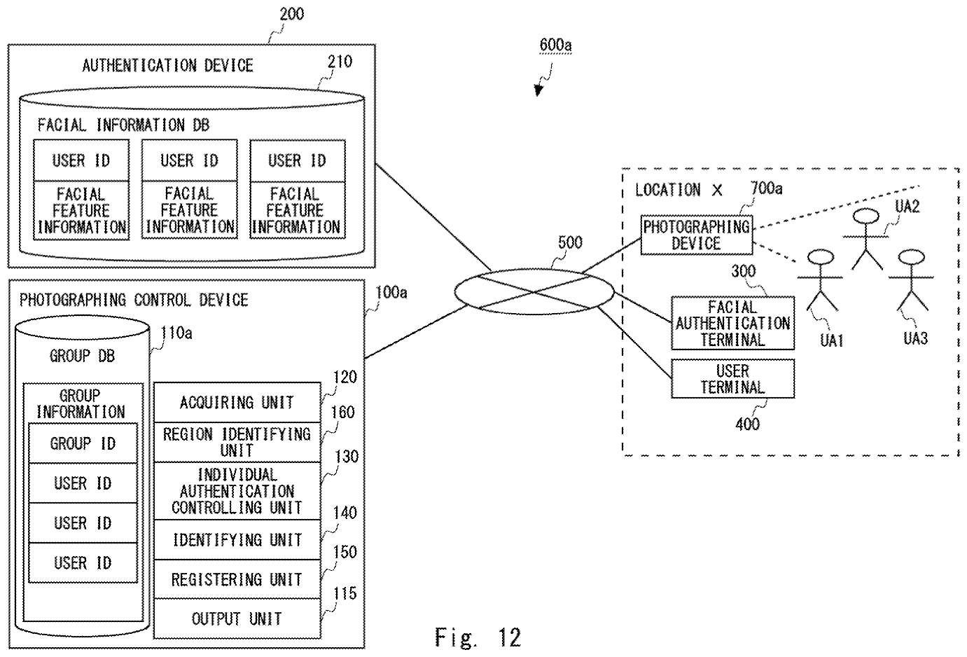

FIG. 12 is a conceptual diagram illustrating a state of the photographing control system 600a held after the user IDs of the users UA2 and UA3 have been registered. The facial information of the users UA2 and UA3 is newly registered in the facial information DB 210 of the authentication device 200. The user IDs of the users UA2 and UA3 are newly registered in the group DB 110a of the photographing control device 100a, and the users UA1, UA2, and UA3 are registered as a group in the group DB 110a. The present example embodiment allows the users to perform group registration without registering facial information of all the group members in advance.

### Fourth Example Embodiment

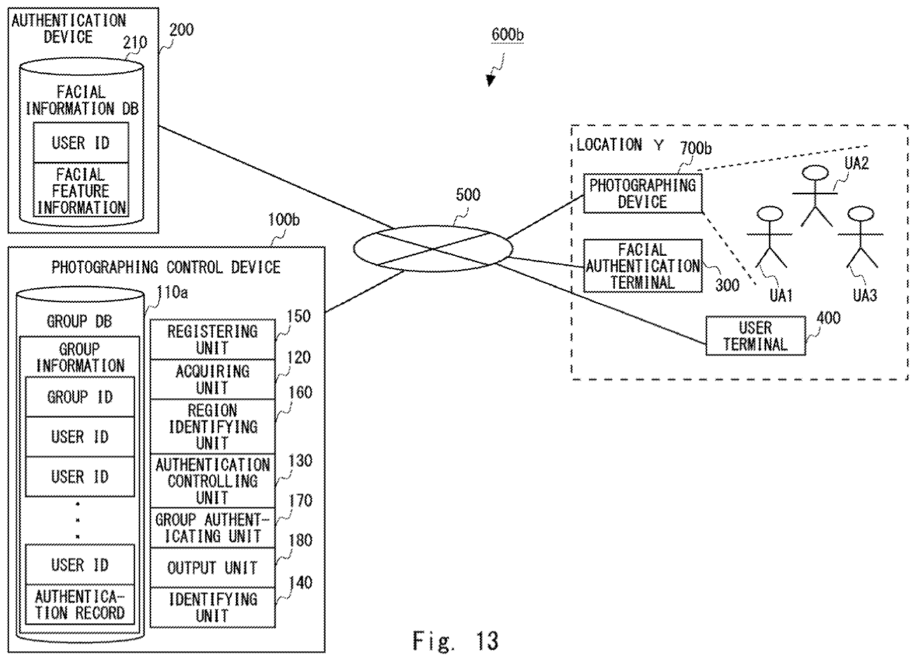

A photographing control system 600b according to a fourth example embodiment performs group authentication after group registration. FIG. 13 is a block diagram illustrating a configuration of the photographing control system 600b according to the fourth example embodiment. The photographing control system 600b includes a photographing control device 100b, an authentication device 200, a photographing device 700b, a facial authentication terminal 300, and a user terminal 400. The photographing control device 100b, the authentication device 200, the photographing device 700b, the facial authentication terminal 300, and the user terminal 400 are connected to each other via a network 500.

As a result of group registration, facial feature information of a plurality of users is registered as a group in a facial feature DB 210 of the authentication device 200. In addition, as a result of group registration, identification information of a plurality of users is registered as a group in a group DB 110a of the photographing control device 100b. In the following, description that is duplicate of the description of the third example embodiment will be omitted as appropriate.

The photographing control device 100b includes the group DB 110a, a registering unit 150, an acquiring unit 120, a region identifying unit 160, an authentication controlling unit 130, a group authenticating unit 170, an output unit 180, and an identifying unit 140. The photographing control device 100b performs control in group authentication described later. Each function of the photographing control device 100a will be described later.

The photographing device 700b photographs users UA1, UA2, and UA3 at a location Y. In this example, the users UA1, UA2, and UA3 are registered as a group. For example, the user UA1 is the first person according to the third example embodiment, and the users UA2 and UA3 are the second person according to the third example embodiment. The photographing control device 100b according to the fourth example embodiment outputs a photographed image if all the members of a predetermined group are photographed altogether. Such a photographed image is referred to as a photographed image for group authentication.

A photographed image for group authentication may be captured at a location X where a photographed image for group registration has been captured or at a location different from the location X. In a similar manner, a second photographing device that captures a photographed image for group authentication may be a device that is the same as or different from a first photographing device that captures a photographed image for group registration. Herein, the facial authentication terminal 300 or the user terminal 400 may capture a photographed image for group authentication.

Next, some functions of the authentication device 200 will be described in detail. The configuration of the authentication device 200 is similar to the configuration according to the third example embodiment. However, the facial information DB 210 has registered therein the user IDs and facial feature information of all the group members. An authenticating unit 250 performs facial authentication by use of a set of facial feature information stored in the facial feature DB 210. The flow of a facial authentication process performed by the authentication device 200 is similar to the flow illustrated in FIG. 9.

Next, the facial authentication terminal 300 will be described in detail. The configuration of the facial authentication terminal 300 is similar to the configuration according to the third example embodiment. However, the facial authentication terminal 300 may include a group image requesting unit 353 that is not illustrated in FIG. 6. The group image requesting unit 353 causes group authentication to be performed by transmitting a photographed image to the photographing control device 100. If all the members of a group are captured in the photographed image, the facial authentication terminal 300 acquires this photographed image from the photographing control device 100b and causes the display unit 340 to display the photographed image.

A group authentication process performed by the facial authentication terminal 300 will be described below. The group image requesting unit 353 transmits a group authentication request including a photographed image obtained by a camera 310 to the photographing control device 100b via the network 500 and receives the result of the group authentication. The group image requesting unit 353 receives the photographed image and causes the display unit 340 to display the photographed image. If facial authentication has failed to succeed for a part of the group members, the group image requesting unit 353 receives a notification indicating that a part of the users is not included and displays to that effect on the display unit 340. If facial authentication has failed for all the group members, the group image requesting unit 353 receives the failure of the facial authentication and displays to that effect on the display unit 340.

Next, the user terminal 400 will be described. The user terminal 400 is, for example, a mobile phone terminal owned by a user. The configuration of the user terminal 400 is similar to the configuration according to the third example embodiment. However, as with the facial authentication terminal 300, the user terminal 400 may include a group image requesting unit 453 that is not illustrated in FIG. 7. The function of the group image requesting unit 453 is similar to the function of the group image requesting unit 353. The group authentication process performed by the facial authentication terminal 300 described above may be performed by the user terminal 400.

Next, referring back to FIG. 13, some functions of the photographing control device 100b will be described. The photographing control device 100b is an information processing device that performs group registration and group authentication and is, for example, a server device implemented by a computer. The group registration is similar to the group registration according to the third example embodiment. Thus, only the group authentication will be described. The photographing control device 100b includes the group DB 110a, the registering unit 150, the acquiring unit 120, the region identifying unit 160, the authentication controlling unit 130, the group authenticating unit 170, the output unit 180, and the identifying unit 140.

The group DB 110a is a database for managing members belonging to a group. Members belonging to a group are also referred to as users. In the group DB 110a, for each record of group information, for example, one group ID, one or more user IDs, and an authentication record are associated with each other. The authentication record is information indicating that group authentication has succeeded. The authentication record may be a flag or may include, for example but not limited to, the date and time when and the location where the group authentication has succeeded. The function of the registering unit 150 is similar to the function according to the third example embodiment, and thus description thereof will be omitted.

The acquiring unit 120 acquires a photographed image from the photographing device 700b, the facial authentication terminal 300, or the user terminal 400. In this example, the photographed image includes not only a photographed image for group registration according to the third example embodiment but also a photographed image for group authentication. Herein, the photographed image includes facial regions of multiple persons. The region identifying unit 160 identifies a plurality of facial regions from the photographed image. For example, the region identifying unit 160 recognizes the plurality of facial regions by analyzing the photographed image. In response to the plurality of facial regions having been identified, the authentication controlling unit 130 causes the authentication device 200 to perform facial authentication of each of the identified facial regions by use of a set of facial feature information.

The group authenticating unit 170 refers to the group DB 110a and performs group authentication. In other words, the group authenticating unit 170 determines whether facial authentication of facial feature information items of the respective persons belonging to the group has succeeded regarding any one of the plurality of facial regions. If the group authentication has succeeded, the group authenticating unit 170 registers the success of the group authentication as an authentication record into the group DB 110a.

Moreover, if the facial regions regarding which the facial feature information items of the respective persons belonging to the group have been successfully authenticated in the facial authentication fall within a predetermined range, the group authenticating unit 170 may register, into the group DB 110a, an association between the success of the group authentication and the group. In other words, the group authenticating unit 170 may be configured not to authenticate as a group when the persons fail to be close to each other within a certain range. For example, a case where the persons belonging to a group are accidentally captured within the same frame is considered inappropriate as a photographed image of the group. Accordingly, by excluding such cases, the accuracy of group authentication can be improved.

The output unit 180 outputs the photographed image as an output image if the group authentication has succeeded. If a part of the facial feature information items of the respective persons belonging to the group fails to succeed in the facial authentication with any one of the plurality of facial regions, the output unit 180 provides an output indicating that the person or persons corresponding to the part of the facial feature information items are not included in the photographed image. In other words, if facial authentication of a part of the group members has failed, the output unit 180 provides an output indicating that a part of the users is not included in the photographed image.

Herein, the group authenticating unit 170 may edit the photographed image so as to highlight the user or users whose facial authentication has succeeded or failed. In that case, the output unit 180 outputs the edited image as an output image. This configuration allows the group members to readily recognize the user whose facial authentication has failed. Moreover, the above configuration allows the group members to readily grasp which member is not included when the group has a large number of members.

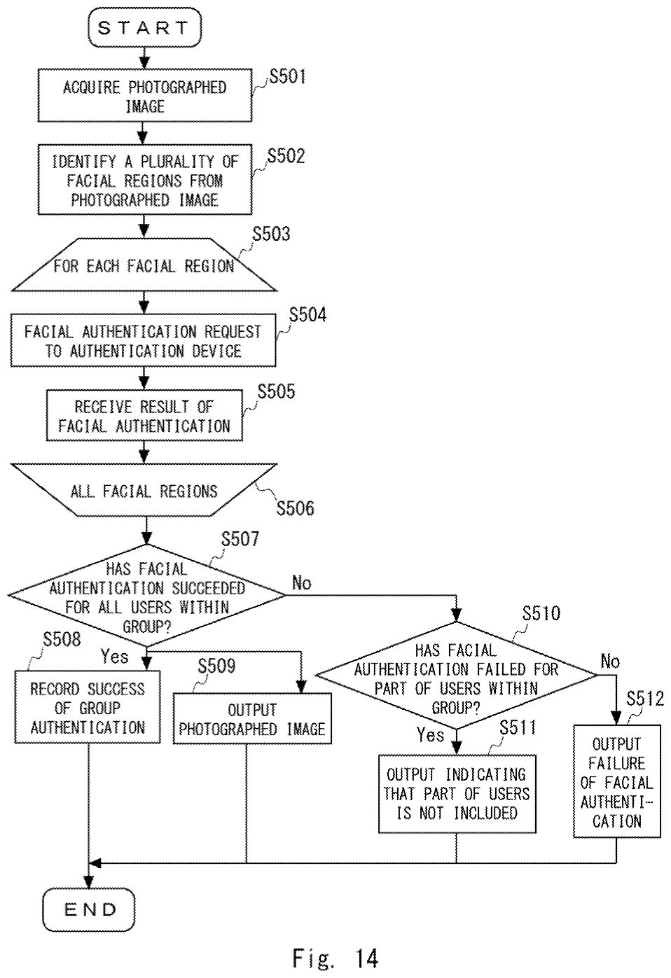

FIG. 14 is a flowchart illustrating a flow of a group authentication process. The user ID of the user UA1, the user ID of the user UA2, and the user ID of the user UA3 are associated as a group A and registered in the group DB 110a.

First, the acquiring unit 120 of the photographing control device 100b acquires a photographed image from the photographing device 700b (step S501). Next, the region identifying unit 160 identifies a plurality of facial regions from the photographed image (step S502). Next, the authentication controlling unit 130 causes the authentication device 200 to perform facial authentication of each of the identified facial regions and receives the result of the facial authentication (step S503 to step S506).

After the facial authentication has been performed regarding all of the plurality of facial regions identified at step S502, the group authenticating unit 170 determines whether the facial authentication has succeeded for all the users within the group (step S507). For example, if the group authenticating unit 170 has received, as the result of the facial authentication, the ID of the user UA1, the ID of the user UA2, and the ID of the user UA3, the group authenticating unit 170 determines that the facial authentication has succeeded for all the users within the group. Meanwhile, for example, if the group authenticating unit 170 has received, as the result of the facial authentication, the ID of the user UA1 and the ID of the user UA2 but not the ID of the user UA3, the group authenticating unit 170 determines that the group authentication has failed.

If the facial authentication has succeeded for all the users within the group (Yes at step S507), the group authenticating unit 170 records the success of the group authentication (step S508). For example, the group authenticating unit 170 updates the group DB 110b by adding this success of the group authentication into the authentication record associated with the group A. Moreover, if the facial authentication has succeeded for all the users within the group, the output unit 180 outputs the photographed image (step S509).

If the facial authentication has not succeeded for all the users within the group (No at step S507), the group authenticating unit 170 determines whether the facial authentication has failed for a part of the users within the group (step S510). The case where the facial authentication has failed for a part of the users within the group means, for example, a case where the authentication controlling unit 130 has received, as the result of the authentication, the user ID of the user UA1 and the user ID of the user UA2 but not the user ID of the user UA3 from the authentication device 200. If the facial authentication has failed for a part of the users within the group (Yes at step S510), the output unit 180 provides an output indicating that a part of the users is not included (step S511). Herein, the output at step S511 may be provided, for example, to the user terminal 400 to which the user UA1 or the user UA2, for which the facial authentication has succeeded, has logged in with his or her user ID or to the display unit 340 of the facial authentication terminal 300 or the like, which is user-independent. In this example, the assumption is that the user ID of the user UA2 has been received as a result of group registration.

The group authenticating unit 170 may identify the user or users for which the facial authentication has failed based on the difference between the user IDs of all the members within the group and the user IDs of the users for which the facial authentication has succeeded. Then, the output unit 180 may provide, to the user terminal 400 of an identified user, an output indicating that the facial authentication of that user has failed. Furthermore, the output unit 180 may notify this identified user of a reason why the group authentication has failed. Examples of reasons why the group authentication has failed include that this user is apart from the other members of the group or that the facial authentication of this user has failed. In this example, the group authenticating unit 170 may offer this user guidance for rephotographing so that the user approaches the other members or the user turns his or her face toward the camera.

If the facial authentication has failed for all the users within the group (No at step S510), the output unit 180 outputs the failure of the facial authentication (step S512). Herein, the output at step S512 may be provided to the display unit 340 of the facial authentication terminal 300 or the like, which is user-independent.

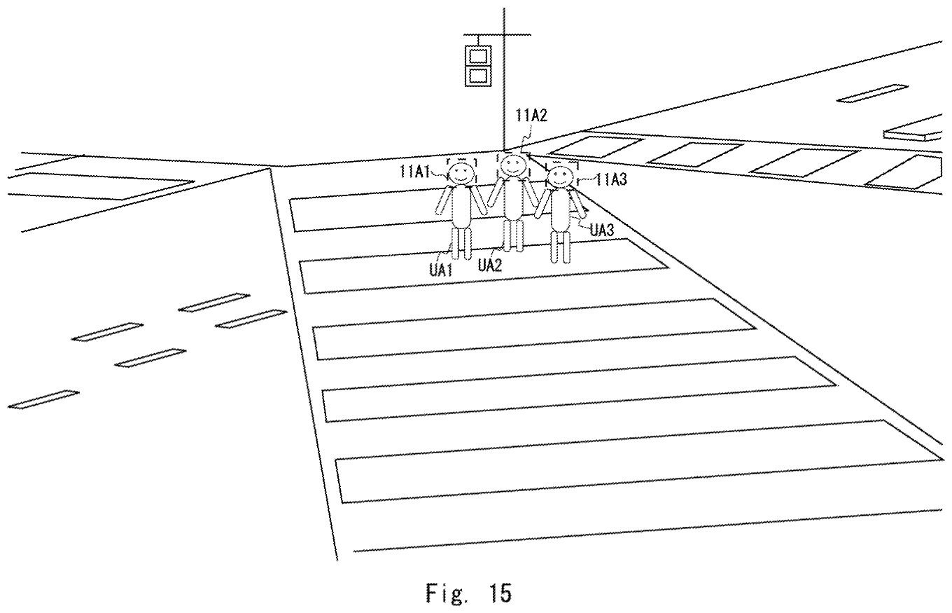

FIG. 15 illustrates an example of a photographed image obtained by the photographing device 700b. The user UA1, the user UA2, and the user UA3 are members of a group. The photographing control device 100b identifies facial regions 11A1, 11A2, and 11A3 and causes the authentication device 200 to perform facial authentication. The authentication device 200 transmits the user IDs of the users UA1, UA2, and UA3. The photographing control device 100a determines that the group authentication has succeeded and outputs the photographed image. The present example embodiment allows the users to obtain a group picture capturing all the members of the group.

### Fifth Example Embodiment

A photographed image obtained by the photographing device 700b according to the fourth example embodiment may include persons from a plurality of groups. If this is the case, it is desirable to provide privacy protection on a group by group basis. A photographing control device 100c according to a fifth example embodiment provides privacy protection on a group by group basis and sorts persons in a photographed image into a plurality of groups.

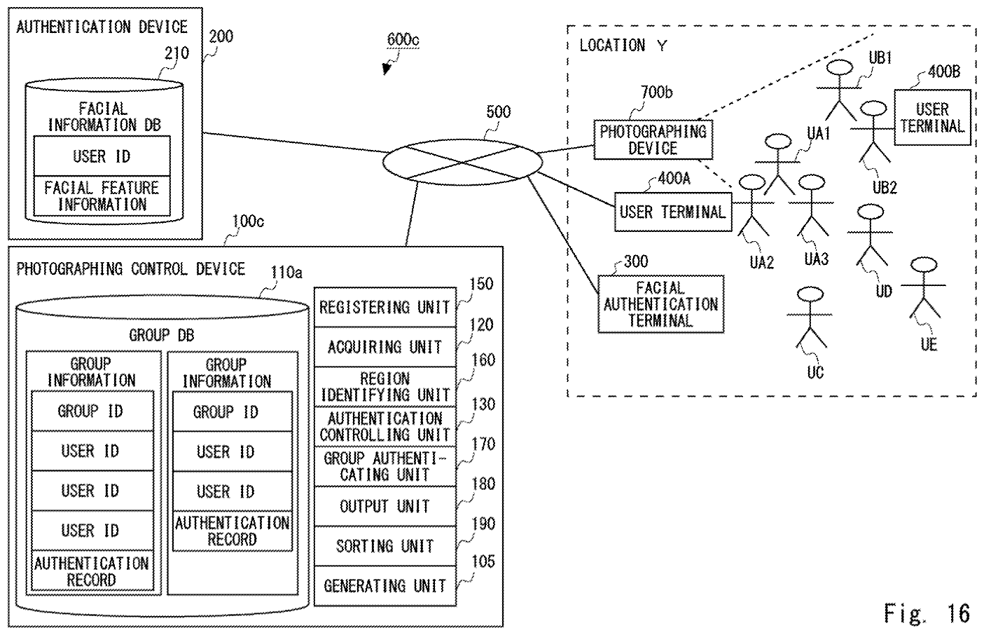

FIG. 16 is a block diagram illustrating a configuration of a photographing control system 600c according to the fifth example embodiment. The photographing control device 100c, an authentication device 200, a photographing device 700b, a facial authentication terminal 300, and user terminals 400 are connected to each other via a network 500, as in the third example embodiment. The authentication device 200, the photographing device 700b, the facial authentication terminal 300, and the user terminals 400 are similar to the counterparts according to the fourth example embodiment, and thus description thereof will be omitted.

The photographing control device 100c includes a group DB 110a, a registering unit 150, an acquiring unit 120, a region identifying unit 160, an authentication controlling unit 130, a group authenticating unit 170, an output unit 180, a sorting unit 190, and a generating unit 105. The functions of the registering unit 150, the acquiring unit 120, the region identifying unit 160, the authentication controlling unit 130, and the output unit 180 are similar to those according to the fourth example embodiment, and thus description thereof will be omitted.

The group DB 110a has two group information items registered therein. For example, users UA1, UA2, and UA3 are registered in a group ID:A, and users UB1 and UB2 are registered in a group ID:B.

A plurality of users UA1, UA2, UA3, UB1, UB2, UC, UD, and UE are at a location Y. The users UA1, UA2, and UA3 are members of a group A. The users UB1 and UB2 are members of a group B. The users UC, UD, and UE are persons who do not belong to either of the group A or B.

The sorting unit 190 of the photographing control device 100c sorts each facial region that has succeeded in facial authentication into the group that includes the corresponding facial feature information. For example, if facial authentication has succeeded for the users UA1, UA2, UA3, UB1, and UB2, their facial regions are each sorted into the group A or the group B.

When facial authentication of all the facial feature information belonging to a group has succeeded, the group authenticating unit 170 registers an association between that group and the success of the group authentication into the group DB 110a. For example, if group authentication has succeeded for the groups A and B, the group authenticating unit 170 registers the success of the group authentication into the authentication records of the respective groups.

The generating unit 105 generates, for each group, an edited image obtained by editing a photographed image so as to reduce the recognizability of a facial region, among a plurality of facial regions, of a person who does not belong to the specific group. For example, in an edited image for the group A, the facial regions of the users UB1, UB2, UC, UD, and UE, who do not belong to the group A, are subjected to mosaic processing. Meanwhile, in an edited image for the group B, the facial regions of the users UA1, UA2, UA3, UC, UD, and UE, who do not belong to the group B, are subjected to mosaic processing.

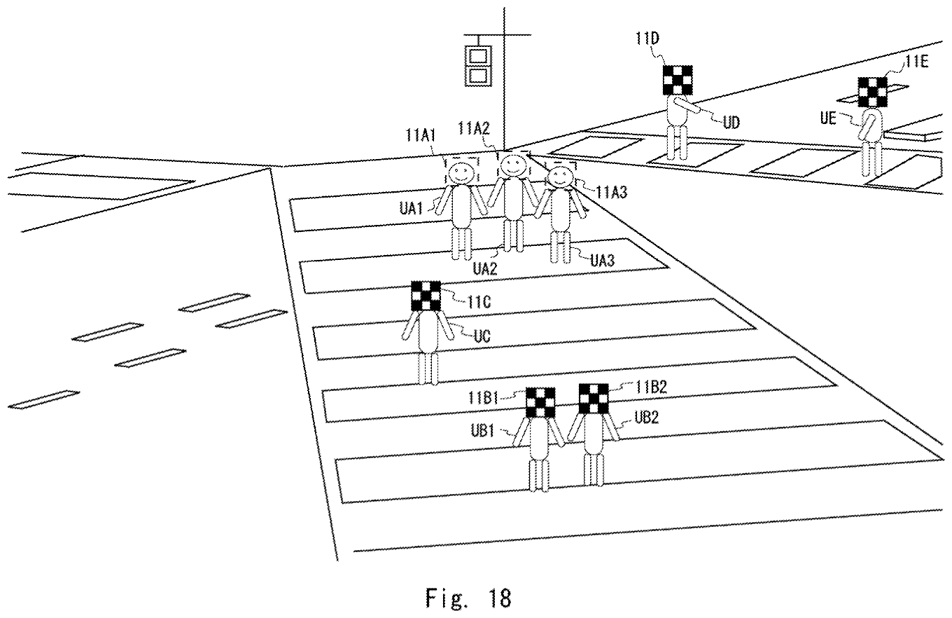

FIG. 18 illustrates an example of an edited image that the generating unit 105 generates. FIG. 18 illustrates an edited image for the group A. Facial regions 11B1 and 11B2 of the respective users UB1 and UB2 belonging to the group B have been subjected to mosaic processing so as to reduce their recognizability. Facial regions 11C, 11D, and 11E of the respective users UC, UD, and UE, who do not belong to any group, have been subjected to mosaic processing so as to reduce their recognizability. In contrast, facial regions 11A1, 11A2, and 11A3 of the respective users UA1, UA2, and UA3 belonging to the group A are not subjected to mosaic processing.

In a similar manner, in an edited image for the group B, the facial regions 11A1, 11A2, and 11A3 of the respective users UA1, UA2, and UA3 belonging to the group A are subjected to mosaic processing so as to reduce their recognizability. In addition, the facial regions 11C, 11D, and 11E of the respective users UC, UD, and UE, who do not belong to any group, are subjected to mosaic processing so as to reduce their recognizability. In contrast, in the edited image for the group B, the facial regions 11B1 and 11B2 of the respective users UB1 and UB2 belonging to the group B are not subjected to mosaic processing.

The output unit 180 outputs, to the user terminal 400 of a user in a given group, an edited image corresponding to that group as an output image. For example, an edited image for the group A is output to the user terminal 400 of the user UA2 belonging to the group A. The user UA2 is logged in to the user terminal 400 with his or her user ID. Herein, the user UA2 can find his or her user ID from the result of group registration. In a similar manner, the output unit 180 outputs an edited image for the group B to the user terminal 400 of the user UB2 belonging to the group B.

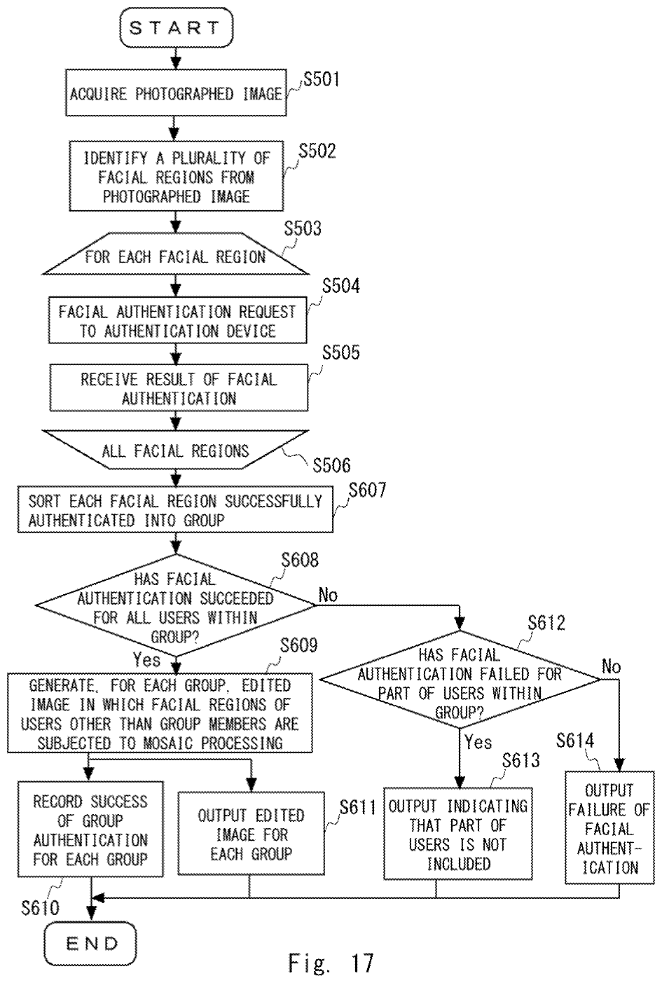

FIG. 17 is a flowchart illustrating a flow of a group authentication process. Step S501 to step S506 are similar to those of FIG. 14, and thus description thereof will be omitted. At step S607, the sorting unit 190 sorts each facial region that has succeeded in the facial authentication into a group. Next, the photographing control device 100c determines whether the facial authentication has succeeded for all the users within a group (step S608).

For the group in which the facial authentication has succeeded for all the users therewithin, the photographing control device 100c generates an edited image as described above (step S609), records the success of the group authentication (step S610), and outputs the edited image (step S611). As described above, an edited image is generated for each group.

If the facial authentication has failed for at least a part of the members of the group, the photographing control device 100c determines whether the facial authentication has failed for a part of the group or for all the users of the group (step S612). If the facial authentication has failed for a part of the group, the photographing control device 100c provides an output to that effect (step S613). In this example, the photographing control device 100c may identify a person for whom the facial authentication has failed and offer guidance for rephotographing to the user terminal 400 of the identified person. If the facial authentication has failed for all the users of the group, the photographing control device 100c outputs the failure of the facial authentication (step S614).

This configuration subjects an output image of a user belonging to the group A to mosaic processing in the facial regions of users other than those in the group A. Accordingly, the above configuration can protect the privacy of the users of the group B or the users who do not belong to any group.

The foregoing example embodiments have been described as hardware configurations, but these are not limiting examples. The present disclosure can also be implemented via desired processes by causing a CPU to execute a computer program.

In the foregoing examples, a program can be stored and provided to a computer by use of various types of non-transitory computer-readable media. Non-transitory computer-readable media include various types of tangible storage media. Examples of such non-transitory computer-readable media include a magnetic recording medium (e.g., flexible disk, magnetic tape, hard-disk drive), a magneto-optical recording medium (e.g., magneto-optical disk), a CD-ROM (read-only memory), a CD-R, a CD-R/W, a DVD (digital versatile disc), and a semiconductor memory (e.g., mask ROM, PROM (programmable ROM), EPROM (erasable PROM), flash ROM, RAM (random-access memory)). Meanwhile, a program may be supplied to a computer by use of various types of transitory computer-readable media. Examples of such transitory computer-readable media include an electric signal, an optical signal, and an electromagnetic wave. A transitory computer-readable medium can supply a program to a computer via a wired communication line, such as an electric wire or an optical fiber, or via a wireless communication line.

It is to be noted that the present disclosure is not limited to the foregoing example embodiments, and modifications can be made, as appropriate, within the scope that does not depart from the technical spirit. The present disclosure may also be implemented by combining the example embodiments, as appropriate.

A part or the whole of the foregoing example embodiments can also be expressed as in the following supplementary notes, which are not limiting.

### Supplementary Note 1

A photographing control device comprising:

acquiring means for acquiring a first photographed image obtained by a first photographing device and capturing multiple persons;

authentication controlling means for causing an authentication device storing in advance first facial feature information of a first person to perform facial authentication of the first photographed image by use of the first facial feature information; and

identifying means for identifying a second person making a gesture similar to a gesture of the first person in the first photographed image, if the facial authentication has succeeded.

### Supplementary Note 2

The photographing control device according to Supplementary Note 1, further comprising registering means for registering, into the authentication device, second facial feature information generated based on a facial region of the second person identified in the first photographed image and register, into storing means, an association between second identification information of the second person and first identification information of the first person.

### Supplementary Note 3

The photographing control device according to Supplementary Note 2, further comprising storing means,

wherein the storing means stores the first identification information in advance.

### Supplementary Note 4

The photographing control device according to any one of Supplementary Notes 1 to 3, further comprising group image output means for outputting, after identifying the second person, an image that is the first photographed image or a part of the first photographed image and that captures the first person and the second person as a group image.

### Supplementary Note 5

The photographing control device according to any one of Supplementary Notes 1 to 4, wherein the identifying means identifies the second person if the first person and the second person are within a predetermined distance of each other.

### Supplementary Note 6

The photographing control device according to Supplementary Note 2 or 3, wherein the registering means registers, into the storing means, the association between the second identification information and the first identification information if a facial region of the first person and a facial region of the second person are within a predetermined distance of each other.

### Supplementary Note 7

The photographing control device according to any one of Supplementary Notes 1 to 6, wherein the acquiring means notifies a terminal corresponding to the first person of a timing at which the first photographing device performs photographing.

### Supplementary Note 8

The photographing control device according to any one of Supplementary Notes 2, 3, and 6, wherein

the acquiring means acquires a second photographed image obtained by a second photographing device and capturing multiple persons,

the photographing control device further includes region identifying means for identifying a plurality of facial regions from the second photographed image,

the authentication controlling means causes the authentication device to perform facial authentication of each of the identified facial regions by use of a set of the first facial feature information and the second facial feature information, and

the photographing control device further includes output means for outputting the second photographed image as an output image if facial authentication of each of the first facial feature information and the second facial feature information has succeeded regarding any one of the plurality of facial regions.

### Supplementary Note 9

The photographing control device according to Supplementary Note 8, further comprising group authenticating means for registering, into the storing means, an association between a success of group authentication and the first identification information and the second identification information if facial authentication of each of the first facial feature information and the second facial feature information has succeeded regarding any one of the plurality of facial regions.

### Supplementary Note 10

The photographing control device according to Supplementary Note 9, wherein the group authenticating means registers, into the storing means, the association between the success of the group authentication and the first identification information and the second identification information if the facial regions regarding which the facial authentication of the facial feature information of the first person and the facial feature information of the second person has succeeded are within a predetermined distance of each other.

### Supplementary Note 11

The photographing control device according to Supplementary Note 9 or 10, wherein the output means, if facial authentication of a part of the first facial feature information and the second facial feature information has failed to succeed regarding any of the plurality of facial regions, provides an output indicating that a person corresponding to the part of the facial feature information is not included in the second photographed image.

### Supplementary Note 12

The photographing control device according to any one of Supplementary Notes 9 to 11, wherein

the storing means stores a plurality of groups associating the first identification information and the second identification information,

the photographing control device further includes a sorting means for sorting each facial region regarding which the facial authentication has succeeded into any one of the groups to which the corresponding facial feature information belongs, and

the group authenticating means registers, into the storing means, an association between the success of the group authentication and a group in which the facial authentication of all the facial feature information belonging to the group has succeeded.

### Supplementary Note 13

The photographing control device according to any one of Supplementary Notes 8 to 12, further comprising generating means for generating an edited image obtained by editing the second photographed image so as to reduce recognizability of a facial region, among the plurality of facial regions, that does not belong to either the first person or the second person,

wherein the output means outputs the edited image as an output image to a terminal corresponding to the first person or the second person.

### Supplementary Note 14

A photographing control device comprising:

storing means for storing first facial feature information of a first person;

acquiring means for acquiring a first photographed image obtained by a first photographing device and capturing multiple persons;

authenticating means for performing facial authentication of the first photographed image by use of the first facial feature information; and

identifying means for identifying a second person making a gesture similar to a gesture of the first person in the first photographed image, if the facial authentication has succeeded.

### Supplementary Note 15

The photographing control device according to Supplementary Note 14, further comprising:

generating means for generating second facial feature information based on a facial region of the second person identified in the first photographed image; and

registering means for registering an association between the second facial feature information and the first facial feature information into the storing means.

### Supplementary Note 16

A photographing control system comprising:

a photographing control device;

an authentication device including storing means configured to store in advance first facial feature information of a first person and authenticating means configured to perform facial authentication by use of the first facial feature information; and

a first photographing device,

wherein the photographing control device is configured to
acquire a first photographed image obtained by the first photographing device and capturing multiple persons,
cause the authentication device to perform facial authentication of the first photographed image by use of the first facial feature information, and
identify a second person making a gesture similar to a gesture of the first person in the first photographed image, if the facial authentication has succeeded.

### Supplementary Note 17

The photographing control system according to Supplementary Note 16, wherein the photographing control device is configured to register, into the authentication device, second facial feature information generated based on a facial region of the second person identified in the first photographed image and register, into storing means, an association between second identification information of the second person and first identification information of the first person.

### Supplementary Note 18

A photographing control method executed by a computer, the photographing control method comprising:

acquiring a first photographed image obtained by a first photographing device and capturing multiple persons;

causing an authentication device storing in advance first facial feature information of a first person to perform facial authentication of the first photographed image by use of the first facial feature information; and

identifying a second person making a gesture similar to a gesture of the first person in the first photographed image, if the facial authentication has succeeded.

### Supplementary Note 19

A photographing control method executed by a computer including storing means configured to store first facial feature information of a first person, the photographing control method comprising:

acquiring a first photographed image obtained by a first photographing device and capturing multiple persons;

performing facial authentication of the first photographed image by use of the first facial feature information; and

identifying a second person making a gesture similar to a gesture of the first person in the first photographed image, if the facial authentication has succeeded.

### Supplementary Note 20

A non-transitory computer-readable medium storing a photographing control program that causes a computer to execute:

a process of acquiring a first photographed image obtained by a first photographing device and capturing multiple persons;

a process of causing an authentication device storing in advance first facial feature information of a first person to perform facial authentication of the first photographed image by use of the first facial feature information; and

a process of identifying a second person making a gesture similar to a gesture of the first person in the first photographed image, if the facial authentication has succeeded.

### Supplementary Note 21

A non-transitory computer-readable medium storing a photographing control program that causes a computer including storing means configured to store first facial feature information of a first person to execute:

a process of acquiring a first photographed image obtained by a first photographing device and capturing multiple persons;

a process of performing facial authentication of the first photographed image by use of the first facial feature information; and

a process of identifying a second person making a gesture similar to a gesture of the first person in the first photographed image, if the facial authentication has succeeded.

### REFERENCE SIGNS LIST

100, 100a, 100b, 100c PHOTOGRAPHING CONTROL DEVICE

110 STORAGE UNIT

110a, 110b, 110c GROUP DB

120 ACQUIRING UNIT

130 AUTHENTICATION CONTROLLING UNIT

130a AUTHENTICATING UNIT

140 IDENTIFYING UNIT

150 REGISTERING UNIT

115 GROUP IMAGE OUTPUT UNIT

160 REGION IDENTIFYING UNIT

170 GROUP AUTHENTICATING UNIT

180 OUTPUT UNIT

190 SORTING UNIT

105 GENERATING UNIT

200 AUTHENTICATION DEVICE

210 FACIAL INFORMATION DB

220 FACE DETECTING UNIT

230 FEATURE POINT EXTRACTING UNIT

240 REGISTERING UNIT

250 AUTHENTICATING UNIT

300 FACIAL AUTHENTICATION TERMINAL

310 CAMERA

320 STORAGE UNIT

330 COMMUNICATING UNIT

340 DISPLAY UNIT

350 CONTROLLING UNIT

351 PHOTOGRAPHING UNIT

352 REGISTERING UNIT

353 GROUP IMAGE REQUESTING UNIT

400 USER TERMINAL

410 CAMERA

420 STORAGE UNIT

430 COMMUNICATING UNIT

440 DISPLAY UNIT

450 CONTROLLING UNIT

451 PHOTOGRAPHING UNIT

452 REGISTERING UNIT

453 GROUP IMAGE REQUESTING UNIT

500 NETWORK

600, 600a, 600b, 600c PHOTOGRAPHING CONTROL SYSTEM

700 FIRST PHOTOGRAPHING DEVICE

700a, 700b, 700c PHOTOGRAPHING DEVICE

What is claimed is:

1. A photographing control device comprising:
at least one memory storing instructions and at least one processor configured to execute the instructions to;
acquire a first photographed image obtained by a first photographing device and capturing multiple persons;
cause an authentication device storing in advance first facial feature information of a first person to perform facial authentication of the first photographed image by use of the first facial feature information; and
identify a second person making a gesture similar to a gesture of the first person in the first photographed image, if the facial authentication has succeeded.

2. The photographing control device according to claim 1,
wherein the at least one processor is further configured to execute the instructions to:
register, into the authentication device, second facial feature information generated based on a facial region of the second person identified in the first photographed image and register, into the at least one memory, an association between second identification information of the second person and first identification information of the first person.

3. The photographing control device according to claim 2,
wherein the at least one memory is configured to store the first identification information in advance.

4. The photographing control device according to claim 1,
wherein the at least one processor is further configured to execute the instructions to:
output, after identifying the second person, an image that is the first photographed image or a part of the first photographed image and that captures the first person and the second person as a group image.

5. The photographing control device according to claim 1, wherein the at least one processor is further configured to execute the instructions to:
identify the second person if the first person and the second person are within a predetermined distance of each other.

6. The photographing control device according to claim 2, wherein the at least one processor is further configured to execute the instructions to:
register, into the at least one memory, the association between the second identification information and the first identification information if a facial region of the first person and a facial region of the second person are within a predetermined distance of each other.

7. The photographing control device according to claim 1, wherein the at least one processor is further configured to execute the instructions to:
notify a terminal corresponding to the first person of a timing at which the first photographing device performs photographing.

8. The photographing control device according to claim 2, wherein the at least one processor is further configured to execute the instructions to:
acquire a second photographed image obtained by a second photographing device and capturing multiple persons,
identify a plurality of facial regions from the second photographed image,
cause the authentication device to perform facial authentication of each of the identified facial regions by use of a set of the first facial feature information and the second facial feature information, and
output the second photographed image as an output image if facial authentication of each of the first facial feature information and the second facial feature information has succeeded regarding any one of the plurality of facial regions.

9. The photographing control device according to claim 8,
wherein the at least one processor is further configured to execute the instructions to:
register, into the at least one memory, an association between a success of group authentication and the first identification information and the second identification information if facial authentication of each of the first facial feature information and the second facial feature information has succeeded regarding any one of the plurality of facial regions.

10. The photographing control device according to claim 9, wherein the at least one processor is further configured to execute the instructions to:
register, into the at least one memory, the association between the success of the group authentication and the first identification information and the second identification information if the facial regions regarding which the facial authentication of the facial feature information of the first person and the facial feature information of the second person has succeeded are within a predetermined distance of each other.

11. The photographing control device according to claim 9, wherein the at least one processor is further configured to execute the instructions to:
if facial authentication of a part of the first facial feature information and the second facial feature information has failed to succeed regarding any of the plurality of facial regions, provide an output indicating that a person corresponding to the part of the facial feature information is not included in the second photographed image.

12. The photographing control device according to claim 9, wherein
the at least one memory is configured to store a plurality of groups associating the first identification information and the second identification information,
the at least one processor is further configured to execute the instructions to:
sort each facial region regarding which the facial authentication has succeeded into any one of the groups to which the corresponding facial feature information belongs, and
register, into the at least one memory, an association between the success of the group authentication and a group in which the facial authentication of all the facial feature information belonging to the group has succeeded.

13. The photographing control device according to claim 8,
wherein the at least one processor is further configured to execute the instructions to:
generate an edited image obtained by editing the second photographed image so as to reduce recognizability of a facial region, among the plurality of facial regions, that does not belong to either the first person or the second person, and
output the edited image as an output image to a terminal corresponding to the first person or the second person.

14-17. (canceled)

18. A photographing control method executed by a computer, the photographing control method comprising:
acquiring a first photographed image obtained by a first photographing device and capturing multiple persons;
causing an authentication device storing in advance first facial feature information of a first person to perform facial authentication of the first photographed image by use of the first facial feature information; and
identifying a second person making a gesture similar to a gesture of the first person in the first photographed image, if the facial authentication has succeeded.

19. (canceled)

20. A non-transitory computer-readable medium storing a photographing control program that causes a computer to execute:
a process of acquiring a first photographed image obtained by a first photographing device and capturing multiple persons;
a process of causing an authentication device storing in advance first facial feature information of a first person to perform facial authentication of the first photographed image by use of the first facial feature information; and
a process of identifying a second person making a gesture similar to a gesture of the first person in the first photographed image, if the facial authentication has succeeded.

21. (canceled)
